(19) United States
(12) Patent Application Publication
(10) Pub. No.: US 2006/0095900 A1
(43) Pub. Date: May 4, 2006

(54) Semantic processor for a hardware database management system

(75) Inventors: Frederick R. Petersen, Dallas, TX (US); Zhixuan Zhu, Dallas, TX (US)

Correspondence Address: DLA PIPER RUDNICK GRAY CARY US, LLP, 2000 UNIVERSITY AVENUE, E. PALO ALTO, CA, 94303-2248, US

(73) Assignee: Calpont Corporation, Rockwall, TX (US)

(21) Appl. No.: 10/927,355

(22) Filed: Aug. 26, 2004

(51) Int. Cl. G06F 9/45

(52) U.S. Cl. 717/142; 717/143

(57) ABSTRACT

A semantic processor for a hardware database management system is described that is operable to take statements in a standardized language and parse those statements. The semantic processor includes a tokenizer for separating the statement into its individual elements and identifying keywords and operators. A precedence engine then orders the elements of the statement into the proper execution order and a function compiler creates an execution tree and determines which element are free of dependencies and can be executed.

### TECHNICAL FIELD OF THE INVENTION

The present invention relates to semantic processors operable to parse structured statements which are then used to access data in a hardware database management system.

### BACKGROUND OF THE INVENTION

Languages of all kinds are made individual elements arranged according to a set of rules, or grammar. A grammar is a set of rules that describe the structure, or syntax of a particular language. This applies not only to spoken languages but to all sorts of other types of languages, including computer programming languages, mathematics, genetics, etc. Statements in a language are functional groupings of individual elements that when interpreted according to the grammar for the language hold a particular meaning, or result in a specified action.

In order for computer processors to process languages, statements in those languages need to be broken down into their individual elements and ordered in manner such that the processor can work with the statement, a process referred to as parsing. Parsing is the process of matching grammar symbols to elements in the language being parsed, according to the rules of grammar for that language.

Once the syntax of particular language has been described by grammar rules, a semantic processor can use the grammar to parse statements in the language. The semantic processor works to break the statements into its individual elements and then uses the grammar for the language to identify the elements and their function within the statement. Some of the elements in the statement can be data, while other elements can be operators which refer to a particular function. For example, the statement “2+3=5” can be broken into its individual elements “2”, “+”, “3”, “C=”, and “5”, where according to mathematical grammar, the “+” and “=” are recognized as operators and the “2”, “3”, and “5” are recognized as data elements. Similarly, statements using standardized computer languages such as the database language Standardized Query Language (“SQL”), or eXtensible Markup Language (XML) can be analyzed in the same manner. These standardized languages can be broken down into operators, keywords, and data elements, and then ordered into execution trees for processing by specialized hardware elements, such as a database management system implemented in hardware.

To get the full benefit from a hardware implementation, the structured database statements, such as SQL statements must be parsed in hardware and converted into formats that take advantage of the hardware nature of the database. Accordingly, what is needed is a semantic processor to parse structured statements for a hardware database management system.

### SUMMARY OF THE INVENTION

The present invention provides for a semantic processor which is able to take statements from a structured language and parse those statements into an execution tree executable by an application processor such as a hardware database. The semantic processor includes a tokenizer, which is operable to identify the individual elements in the statement and recognize keywords and operators. A keyword reduce function then replaces keywords with a hard-coded instruction executable by the application processor. A precedence engine orders the elements of the statement into the order required for execution and creates a tree corresponding to that order. A linker places the elements of that tree into a link list in memory and finally a function compiler reads the tree and determines which elements are free of dependencies and can be executed. The function compiler can then schedule those elements for execution.

The foregoing has outlined, rather broadly, preferred and alternative features of the present invention so that those skilled in the art may better understand the detailed description of the invention that follows. Additional features of the invention will be described hereinafter that form the subject of the claims of the invention. Those skilled in the art will appreciate that they can readily use the disclosed conception and specific embodiment as a basis for designing or modifying other structures for carrying out the same purposes of the present invention. Those skilled in the art will also realize that such equivalent constructions do not depart from the spirit and scope of the invention in its broadest form.

### BRIEF DESCRIPTION OF THE DRAWINGS

For a more complete understanding of the present invention, reference is now made to the following descriptions taken in conjunction with the accompanying drawings, in which:

FIG. 1 illustrates a block diagram of a semantic processor in accordance with the present invention;

FIG. 2 illustrates a block diagram for the tokenizer from FIG. 1;

FIG. 3 illustrates a block diagram of the precedence engine from FIG. 1; and

FIG. 4 illustrates a flow chart showing the parsing of a structured statement in accordance with the present invention.

### DETAILED DESCRIPTION OF THE DRAWINGS

As stated, one use for a semantic processor to process standardized structured language queries, such as those associated with SQL, would be a hardware database management system like the one described in U.S. patent application Ser. No. 10/712,644. In such a hardware database management system, a semantic processor, or parser, is required to process the SQL.statements and to translate them into a form useable by the hardware database management system.

The semantic processor takes each new statement and identifies the operators and their associated data objects. For example, in the SQL statement SELECT DATA FROM TABLE WHERE DATA2=VALUE, the operators SELECT, FROM, WHERE, and = are identified as operators, while DATA, TABLE, DATA and VALUE, are identified as data object. The operators are then converted into executable instructions while the data objects are associated with their corresponding operator and stored in memory. When the semantic processor is finished with a particular statement, a series of executable instructions and links to their associated data are sent for further processing.

Once the executable instructions and data objects are ready to be processed, the semantic processor validates that the executable instructions are proper and valid. The semantic processor then takes the executable instructions forming a statement and builds an execution tree, the execution tree representing the manner in which the individual executable instructions will be processed in order to process the entire statement represented by the executable instructions. An example of the execution tree for the SQL statement SELECT DATA FROM TABLE WHERE DATA2=VALUE can be represented as:

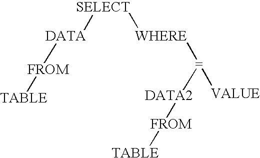

The execution tree once assembled would be executed from the elements without dependencies toward the elements with the most dependencies, or from the bottom up to the top in the example shown. Branches without dependencies on other branches can be executed in parallel to make handling of the statement more efficient. For example, the left and right branches of the example shown do not have any interdependencies and could be executed in parallel.

The semantic processor takes the execution trees and identifies those elements in the trees that do not have any interdependencies and schedules those elements of the execution tree for processing. Each element contains within it a pointer pointing to the location in memory where the result of its function should be stored. When each element is finished with its processing and its result has been stored in the appropriate memory location, that element is removed from the tree and the next element is then tagged as having no interdependencies and it is scheduled for processing.

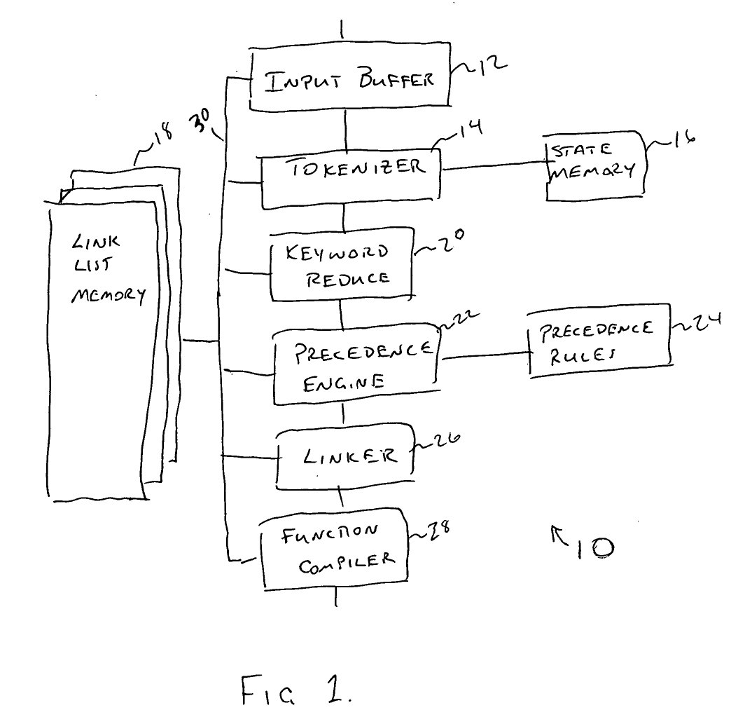

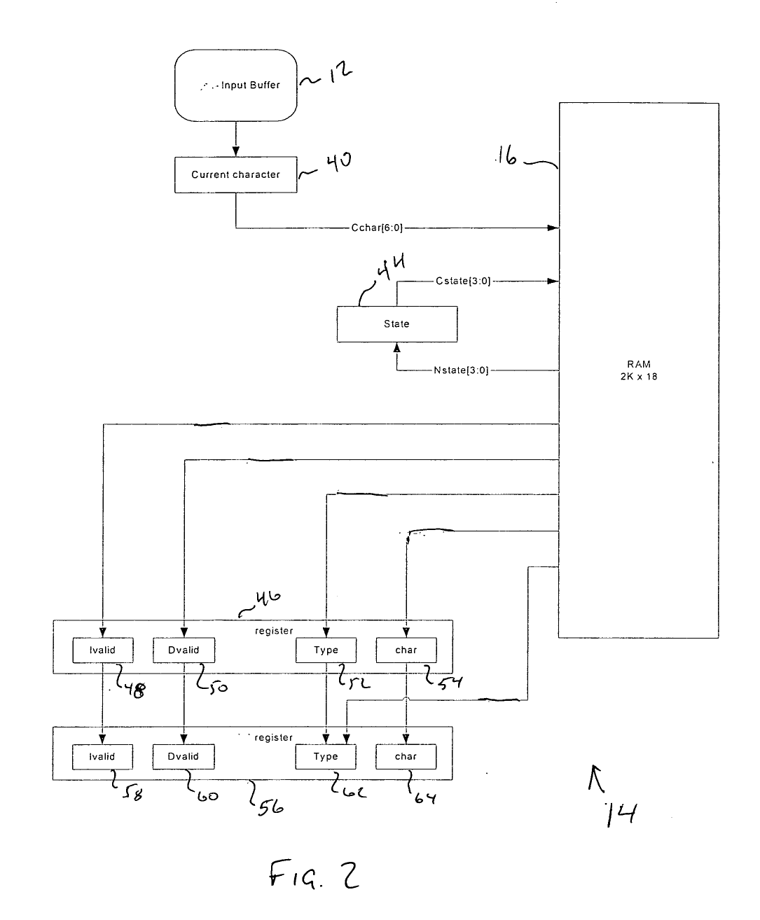

Referring now to FIG. 1 the preferred embodiment of a semantic processor according to the present invention is shown. The semantic processor 10 receives structured language statements, such as SQL, XML or any other structured language with operators, keywords and semantic rules, in input buffer 12 which queues statements for processing by semantic processor 10. The input buffer feeds the statements to tokenizer 14 which breaks the statements down into their individual elements on a character by character basis, and removes white space and case dependencies. The tokenizer 14 is also able to recognizer the first level of operators associated with the structured statement language. The tokenizer 14 will be discussed in greater detail with reference to FIG. 2. State memory 16 is used by tokenizer 14 as it identifies elements on a character by character basis. The tokenizer is connected to link list memory 18 through memory bus 30. Link list memory stores the links between the operators and keywords and their associated data elements and stores the actual data elements as they are identified.

The tokenizer 14 send its output to keyword reduce 20. Keyword reduce 20 scans items identified as keywords by the tokenizer, these are items identified as non-operators, and non-data elements. In SQL, for example, these would be SQL keywords such as SELECT, FROM, etc., or non-keyword, non-data elements such as table names, Keyword reduce 20 replaces the keywords with instruction codes associated with the keywords, and passes the other items such as the table names on as is. Keyword reduce 20 also accesses memory 18 through memory bus 30.

From keyword reduce 20 the elements of the statement, the operators and keywords, and the links to the data elements in link list memory 18, are passed to precedence engine 22. Precedence engine 22 orders the elements of the statement according to the order in which they need to be processed according to rules set programmed into precedence rules 24. For example, if the math function 5*(2+3) were sent to the precedence engine 22, precedence engine 22 would examine precedence rules 24 and be told that parentheticals have precedence over multiply functions and would order the function to be processed by adding 2 to 3 before multiplying by 5. The output of the precedence engine 22 is a tree such as the example set forth above for the SELECT statement.

After precedence engine 22 has determined the correct order of execution for the elements in the statement and produced a corresponding tree that information is passed to linker 26. Linker 26 converts the tree into a link list between elements and places that linked tree into memory 18 using memory bus 30. The linked statement will stay in link list memory 18 while it is executed.

From the linker 26 the tree is passes to function compiler 28 which walks the trees to identify which elements are ready for execution. Any function without dependencies can be identified by the function compiler and sent off for execution. Any statement can have multiple functions being executed at the same time as described above.

Referring now to FIG. 2 a more detailed diagram of the tokenizer 14 form FIG. 1 is shown. Tokenizer 14 received statements from input buffer 12 from FIG. 1, which feeds the tokenizer the elements of the statement one character at a time. Individual elements in the statement are identified by the presence of white space and grouped together. The white space is then dropped. The current character 40 is received from input buffer 12 and fed to state memory 16 from FIG. 1. If it is the first character of a grouping, state memory 16, creates a state 44 representing all possible states that could begin with that character.

The states include operators, keywords, non-keyword functions, such as table names in SQL, data elements, and other identifiable semantic elements associated with the language being processed. Each subsequent character is then loaded into current character 40 and using the state from the previous character 44, has a new state determined by state memory 16. As each element is processed the characters 54 and 56 are loaded into registers, 46 and 56, which also include the results of the state lookup process. These include flags IValid, 48 and 58 and DValid 50 and 60 which are set when the current element is either finally, or intermediately determined to be a valid instruction or operator, in the case of the IValid flag 48 and 58, or a valid data element, in the case of DValid flag 50 and 60. The registers also include a field, type 52 and 62, which identifies which type of semantic element is finally, or intermediately, represented by the element being processed.

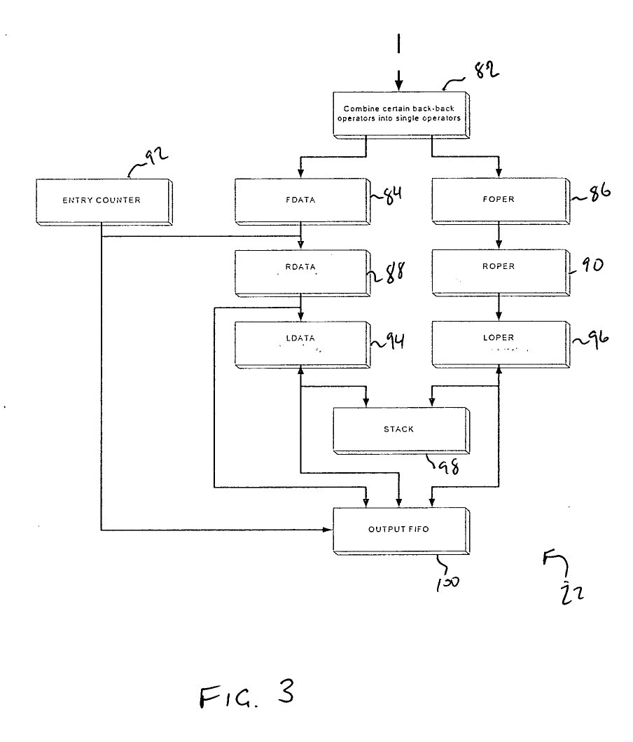

Referring now to FIG. 3, a more detailed diagram of the precedence engine 22 from FIG. 1 is shown. Structured statements already processed by the tokenizer 14 and keyword reduce 20 from FIG. 1, are fed to the precedence engine 22. Combine function 82 allows certain types of operators, such as back-to-back operators to be combined into a single operator for the purposes of the precedence determination. From combine function 82, operators are paired with their associated data and fed into operator register and paired data registers, the operator registers are shown as FOPER 86, ROPER 90, and LOPER 96, while the data registers are shown as FDATA 84, RDATA 88, and LDATA 94. The operator and data pairs are fed sequentially through the operator and data registers. At each stage the operator pairs are analyzed against the precedence rules 24 from FIG. 1. Pairs out of correct precedence order are stored in stack 98, and replaced in the registers when the higher precedence pairs have passed through the registers. Stack 98 is also used to store parenthetical elements until the entire parenthetical has been processed. Entry counter 92 keeps track of the length of statements and parentheticals. Once the pairs are in the correct position, or order, they are passed out of the precedence engine through output fifo 100, and then passed to linker 26 from FIG. 1.

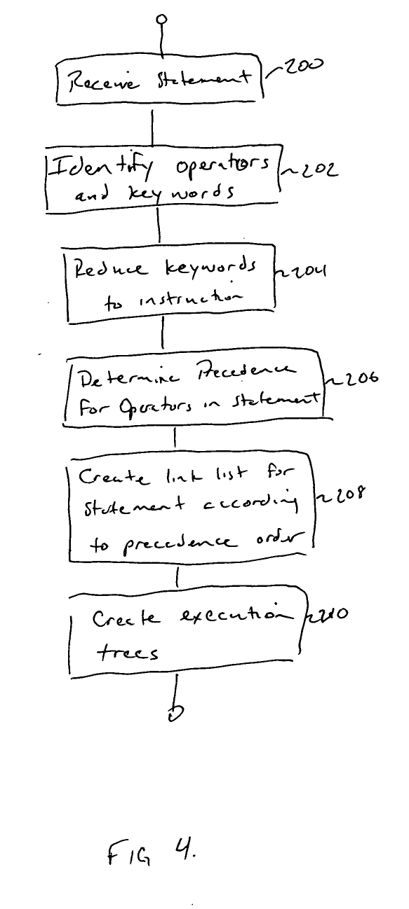

Referring now to FIG. 4, a method of processing structured language statements is described. The method begins when in block 200 when a statement is received. The method then passes to block 202 where the operators and keywords are identified. The keywords are then reduced to instructions in block 204. Once the keywords and operators have been identified and associated with their corresponding data objects, the method passes to block 206 where the precedence of the operators and keywords making up the statement is determined. Block 208 then places the output of the precedence determination into a link list according to precedence order. Finally, block 210 represents the creation of execution trees from the link listed elements where the functions without dependencies are identified and scheduled for execution.

Although particular references have been made to specific protocols such as SQL, and XML, implementations and materials, those skilled in the art should understand that the database management system can function with any protocol producing structured statements, and in a variety of different implementations without departing from the scope of the invention in its broadest form.

We claim:

1. A semantic processor for parsing structured language statements comprising:
a tokenizer receiving the incoming statements and separating the statement into its individual elements and identifying operators in the statements, wherein the tokenizer replaces each operator with a corresponding code; and
a precedence engine operable to take the operators from the tokenizer and order the operators according to their relative precedence.

2. The semantic processor of claim 1 further comprising a function compiler, the execution compiler taking the output of the precedence engine and creating an execution tree.

3. The semantic processor of claim 1 wherein the tokenizer also identifies non-operator strings in the statements, stores the strings in memory, and associates a pointer with the string.

4. The semantic processor of claim 1 wherein structured language statements are database queries.

5. The semantic processor of claim 4 wherein the database queries use Structured Query Language.

6. The semantic processor of claim 4 wherein the database queries use eXtensible Markup Language.

7. The semantic processor of claim 1 further comprising a keyword reduce function which is operable to substitute hard-coded instructions for keywords.

8. The semantic processor of claim 1 wherein the tokenizer compares each character in the incoming statement against a state memory holding potential keywords for the structured statement.

9. The semantic processor of claim 1 further comprising a linker operable to take the results from the precedence engine and create a link list for the statement.

10. A method for parsing a structured language statement in hardware, the method comprising:
separating individual elements of the statement into discrete objects;
identifying which of the discrete objects represent operators and keywords;
determining the relative precedence for each operator and keyword in the statement; and
creating an execution tree for the statement.

11. The method of claim 10 further where the separating and identifying are performed by a tokenizer.

12. The method of claim 10 wherein the determining is performed by a precedence engine having a rules table.

13. The method of claim 12 wherein the structured language is a standardized database language.
